(19) United States
(12) Patent Application Publication
(10) Pub. No.: US 2014/0036195 A1
(43) Pub. Date: Feb. 6, 2014

(54) LCD Device and a Frame Unit Thereof and an Alignment Method of a Liquid Crystal Panel

(71) Applicants: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(72) Inventors: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(21) Appl. No.: 13/641,107

(22) PCT Filed: Aug. 9, 2012
(86) PCT No.: PCT/CN12/79858

§ 371 Date: Oct. 13, 2012

(30) Foreign Application Priority Data
Jul. 31, 2012 (CN) 201210271282.X

(51) Int. Cl. G02F 1/1333

(52) U.S. Cl. CPC G02F 1/133308
USPC 349/58; 445/24; 211/26

(57) ABSTRACT

A liquid crystal display (LCD) device and a frame unit thereof are proposed. The frame unit includes a frame and a back plate unit. The frame includes a cover plate and a rib connected to the cover plate. The cover plate props the upper surface of a liquid crystal panel in the LCD device flexibly. The rib props the lateral side of the liquid crystal panel flexibly. The back plate unit includes a bottom plate and a side plate connected to the bottom plate. The bottom plate supports an optical component of the LCD device. The side plate works with the rib to prop the liquid crystal panel. An alignment method of the liquid crystal panel is proposed as well. The advantages of the present invention are that the thickness of a bezel of the LCD device is greatly reduced, production costs of the LCD device are decreased, and a design of an extremely narrow bezel is implemented.

### BACKGROUND OF THE INVENTION

1. Field of the Invention.

The present invention relates to liquid crystals, and more particularly, to a liquid crystal display (LCD) device and a frame unit thereof and an alignment method of a liquid crystal panel.

2. Description of the Prior Art

Conventionally, a liquid crystal panel is usually disposed on a backlight module to a form an LCD device. A rib on a housing of the backlight module is used tier propping the liquid crystal panel horizontally. A cover plate on the housing is used for fixing the liquid crystal panel vertically. The cooperation of the rib and the cover plate implements the positioning of the liquid crystal panel.

However, the thickness of the bezel of the LCD device increases because of the rib on the housing, which is disadvantageous of designing an extremely narrow bezel of the LCD device. Also, the liquid crystal panel cannot be accurately positioned due to the housing of the backlight module, which is disadvantageous of implementing automated assembly for the LCD device.

### SUMMARY OF THE INVENTION

Accordingly, the present invention has been made to solve the above-mentioned problems occurring in the prior art, and an aspect of the present invention is to provide an LCD device and a frame unit thereof and an alignment method of a liquid crystal panel for minimizing the thickness of the bezel of the LCD device and for implementing automated assembly for the LCD device.

According to the present invention, a frame unit for a liquid crystal display (LCD) device comprising a frame and a back plate unit is provided. The frame comprises a cover plate and a rib perpendicular to the cover plate. The cover plate is used for propping a upper surface of a liquid crystal panel of the LCD device flexibly The rib is used for propping a lateral side of the liquid crystal panel flexibly. The back plate unit comprises a bottom plate and a side plate, the bottom plate used for supporting an optical component of the LCD device, and the side plate working with the rib to prop the liquid crystal panel. The rib comprises a first rib, a second rib, and a connecting portion connected to the first rib and the second rib, the first rib is disposed closely to the lateral side of the side plate, the connecting portion is disposed close to the end surface of the side plate, and the second rib extends from the connecting portion in the direction against the side plate and is connected to the cover plate.

In one aspect of the present invention, the frame unit further comprises a housing. The housing comprises a vertical portion and a support portion. The vertical portion is inserted between the rib and the side plate, and the support portion props a lower surface of the liquid crystal panel.

In another aspect of the present invention, a containing tank is formed among the support portion, the second rib, and the cover plate for containing and fixing the liquid crystal panel.

In another aspect of the present invention, a buffer material is disposed between the second rib and the lateral side of the liquid crystal panel, between the cover plate and the upper surface of the liquid crystal panel, and between the support portion and the lower surface of the liquid crystal panel.

In still another aspect of the present invention, the frame is numerous in quantity, and the plurality of frames are spaced from one another.

In yet another aspect of the present invention, the plurality of frames are L-shaped and are disposed on a plurality of coner of the liquid crystal panel.

According to the present invention, a liquid crystal display device comprising at frame unit is provided. The frame unit comprises a frame, and a back plate unit. The frame comprises a cover plate and a rib perpendicular to the cover plate. The cover plate is used for propping a upper surface of a liquid crystal panel of the LCD device flexibly. The rib is used for propping a lateral side of the liquid crystal panel flexibly. The back plate unit comprises a bottom plate and a side plate. The bottom plate is used for supporting an optical component of the LCD device, and the side plate working with the rib to prop the liquid crystal panel.

In one aspect of the present invention, the rib comprises a first rib, a second rib, and a connecting portion connected to the first rib and the second rib, the first rib is disposed closely to the lateral, side of the side plate, the connecting portion is disposed close to the end surface of the side plate, and the second rib extends from the connecting portion in the direction against the side plate and is connected to the cover plate.

In another aspect of the present invention, the frame unit further comprises a housing, the housing comprises a vertical portion and a support portion, the vertical portion is inserted between the rib and the side plate, and the support portion props a lower surface of the liquid crystal panel.

In another aspect of the present invention, a containing tank is formed among the support portion, the second rib, and the cover plate for containing and fixing the liquid crystal panel.

In still another aspect of the present invention, as buffer material is disposed between the second rib and the lateral side of the liquid crystal panel, between the cover plate and the upper surface of the liquid crystal panel, and between the support portion and the lower surface of the liquid crystal panel.

In yet another aspect of the present invention, the frame is numerous in quantity, and the plurality of frames are spaced from one another.

According to the present invention, an alignment method of a liquid crystal panel of an LCD device is provided. The alignment method adopts a frame unit as mentioned above. The frame is numerous in quantity, and the alignment method comprises steps of disposing the liquid crystal panel on a back plate unit; and pressing cover plates of the plurality of frames on the upper surface of the liquid crystal panel, and propelling the liquid crystal panel to a predetermined position on the back plate unit with ribs of the plurality of frames to implement positioning of the liquid crystal panel.

A cover plate on a frame of the frame unit is used for propping the upper surface of the liquid crystal panel in the LCD device flexibly in the embodiments of the present invention. A rib on the frame is used for propping a lateral side of the liquid crystal panel flexibly. Such a design allows the liquid crystal panel to be positioned accurately, which is good for implementing automated assembly for the LCD device. Also, it is unnecessary to use the rib of the housing to position the liquid crystal panel horizontally. In other words, the thickness of the betel of the LCD device is reduced, thereby implementing the design of the narrow bezel.

### BRIEF DESCRIPTION OF THE DRAWINGS

FIG. 1 shows a schematic diagram of part of an LCD device using a frame unit according to one embodiment of the present invention.

FIG. 2 showing a schematic diagram of part of an LCD device using a frame unit according to another embodiment of the present invention.

FIG. 3a shows an assembly diagram of an LCD device according to another embodiment of the present invention.

FIG. 3b shows a schematic diagram of the completed LCD device as shown in FIG. 3a.

FIG. 4 shows a flow chart of an alignment method of the liquid crystal panel according to an embodiment of the present invention.

### DETAILED DESCRIPTION OF THE PREFERRED EMBODIMENTS

The present invention will be more apparent from the following detailed description taken in conjunction with the accompanying drawings.

### Embodiment One

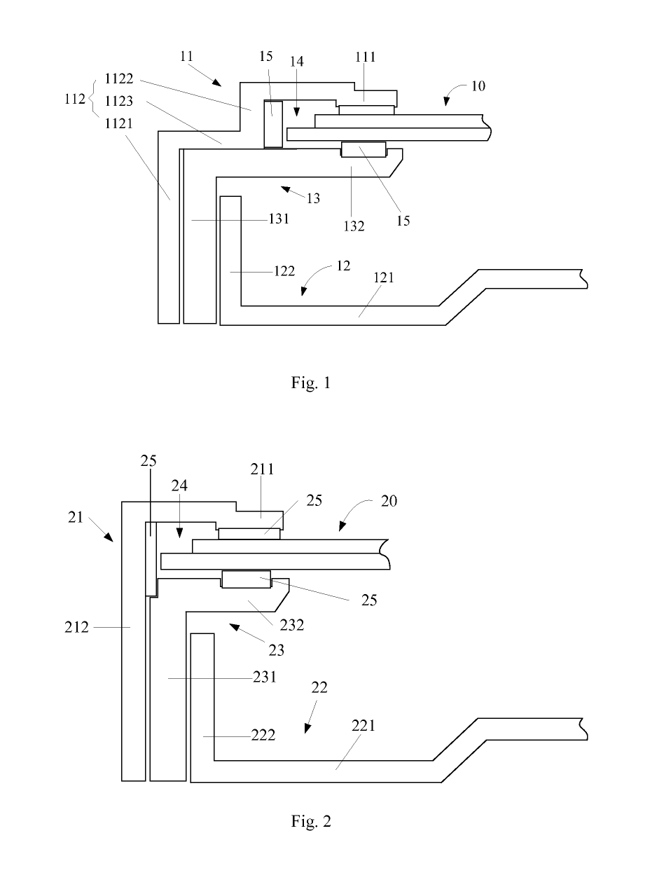

Refer to FIG. 1 showing a schematic diagram of part of an LCD device using a frame unit according to one embodiment of the present invention.

In this embodiment, the LCD device comprises a liquid crystal panel 10 and as frame unit. The frame unit comprises, but is not limited to a frame 11 and a back plate unit 12.

Specifically, one or more frames 11 are used. Each of the one or more frames 11 comprises a cover plate 111 and a rib 112 connected to the cover plate 111. The cover plate 111 props the upper surface of the liquid crystal panel 10, and for producing better effects on fixation, the bottom surface of the cover plate 111 is parallel to the upper surface of the liquid crystal panel 10. The rib 112 is perpendicular to the cover plate 111. The rib 112 props a lateral side of the liquid crystal panel 10 flexibly. Further, the rib 112 comprises a first rib 1121, a second rib 1122, and a connecting, portion 1123 connected to the first rib 1121 and the second rib 1122. The second rib 1122 is connected to one end of the cover plate 111. One end of the connecting portion 1123 is connected to one end of the second rib 1122 which is away from the cover plate 111, and the other end of the connecting portion 1123 is connected to the first rib 1121. Of course, the cover plate 111 can solder the rib 112, or the cover plate 111 and solder the rib 112 have a monocoque-style form. Actually, the formation of the cover plate 111 and the rib 112 is not limited here. The frame 11 is a stepwise-shaped frame. Specifically, the first rib 1121 and the second rib 1122 are disposed in the direction perpendicular to the cover plate 111 or are disposed at a specific tilting angle. The connecting portion 1123 is parallel to the cover plate 111. Actually, the dispositions of the first rib 1121, the second rib 1122, and the connecting portion 1123 are not limited here.

The back plate unit 12 comprises a bottom plate 121 and a side plate 122. Correspondingly, the first rib 1121 is disposed closely to the lateral side of the side plate 122. The connecting portion 1123 is disposed close to the end surface of the side plate 122. The second rib 1122 extends from the connecting portion 1123 in the direction against the side plate 122 and is connected to the cover plate 111. The bottom plate 121 is used for supporting an optical component (not shown) of the LCD device. The side plate 122 may be close to and parallel to the first rib 1121 so that the side plate 122 can work with the rib 112 to prop the liquid crystal panel 10. In other words, a support plate (not shown) may be formed on the end surface of the side plate 122 which is far away from the bottom plate 121. As long as the support plate supports the lower surface of the liquid crystal panel 10 directly and the support plate works with the rib 112, the liquid crystal panel 10 can be successfully propped.

Of course, the frame unit may further comprise a housing 13 in another embodiment. Specifically, the housing 13 comprises a vertical portion 131 and a support portion 132 connected to the vertical portion 131. The vertical portion 131 is inserted between the first rib 1121 and the side plate 122. The vertical portion 131, the first rib 1121, and the side plate 122 may cooperate closely to one another to strengthen the structure oil the frame unit. Unlike the first embodiment, the support portion 132 substitutes for the support plate of the side plate 122 to prop the lower surface of the liquid crystal panel 10. In other words, the liquid crystal panel 10 is supported by the support portion 132 and the connecting portion 1123 which touches the support portion 132. Preferably, a containing tank 14 is formed among the support portion 132, the second rib 1122, and the cover plate 111. The liquid crystal panel 10 is contained and used inside the containing tank 14.

In addition, to firmly fix the liquid crystal panel 10, a buffer material 15 is disposed between the support portion 132 and the liquid crystal panel 10, between the second rib 1122 and the liquid crystal panel 10, and between the cover plate 111 and the liquid crystal panel 10, respectively. For example, an elastic material such as rubber and elastic particles can be used as the buffer material 15 and is attached to the support portion 132, the second rib 1122, and the cover plate 111 directly. The elastic material is not limited here.

Hereinafter, the first embodiment of the present invention will be described with reference to FIG. 1. FIG. 1 shows the positioning of the frame unit and the liquid crystal panel 10. The cover plate 111 presses the upper surface of the liquid crystal panel 10 using the buffer material 15. The support portion 132 supports the lower surface of the liquid crystal panel 10 using the buffer material 15. The lateral side of the liquid crystal panel 10 props the second rib 1122 using the buffer material 15. Since the second rib 1122 works with the lateral side of the liquid crystal panel 10 directly, the thickness of the frame unit is only the thickness of the second rib 1122 which props the liquid crystal panel 10. So the thickness of the bezel is greatly reduced. Also, both of the upper surface of the liquid crystal panel 10 and the lateral side of the liquid crystal panel 10 prop the frame 11, so the liquid crystal panel 10 can be propelled to a predetermined position with the second rib 1122 of the frame 11. Therefore, the liquid crystal panel 10 can be accurately positioned. Further, automated assembly for the LCD device can be implemented.

The cover plate 111 on the frame 11 is used for propping the upper surface of the liquid crystal panel 10 flexibly. The rib 112 on the frame 11 is used for propping the lateral side of the liquid crystal panel 10 flexibly. The design of this embodiment allows the liquid crystal panel 10 to be positioned accurately, which is good for implementing automated assembly for the LCD device. Also, it is unnecessary to use the rib 112 of the housing 13 to position the liquid crystal panel 10 horizontally, which means that the thickness of the bezel of the LCD device is reduced. As a result, the LCD device comprising an extremely narrow bezel is implemented.

### Embodiment Two

Refer to FIG. 2 showing a schematic diagram of part of an LCD device using a frame unit according to another embodiment of the present invention.

In this embodiment, the LCD device comprises a liquid crystal panel 20 and a frame unit. The frame unit comprises, but is not limited, to, a frame 21 and a back plate unit 22.

The frame 21 comprises a cover plate 211 and a rib 212 which is perpendicular to each other. The back plate unit 22 comprises a bottom plate 221 and a side plate 222 connected to the bottom plate 221. The bottom plate 221 is connected to the side plate 222. What is worth of noting is that the rib 212 is parallel to a vertical portion 231 and the side plate 222 in the second embodiment while the frame 11 is stepwise-shaped frame in the first embodiment. That is, the rib 212 is not formed by a first rib, a second rib, and a connecting portion which are connected to one another. The rib 212 and the cover plate 211 are perpendicular to each other. Since the components used in the second embodiment are the same as those used in the first embodiment, no details of the components in the second embodiment are provided.

In this embodiment, a support plate (not shown) is formed on the end of the side plate 222 which is far away from the bottom plate 221. The lower surface of the liquid crystal panel 20 is supported by the support plate directly. Also, the cooperation of the support plate and the rib 212 prop the liquid crystal panel 20 together. In another embodiment, the frame unit further comprises a housing 23 for propping the liquid crystal panel 20. For example, the housing 23 comprises a vertical portion 231 and a support portion 232 connected to the vertical portion 231. The support portion 232 supports the lower surface of the liquid crystal panel 20. The housing 23 used in this embodiment are the same as that used in the first embodiment. Since, the structure of the housing 13 is elaborated, the structure of the housing 23 will not be further described below. Preferably, a containing tank 24 is formed among the support portion 232, the rib 213, and the cover plate 211. The liquid crystal panel 20 is contained and fixed in the containing tank 24.

In addition, to firmly fix the liquid crystal panel 20, a buffer material 25 is disposed between the support portion 232 and the liquid crystal panel 20, between the rib 212 and the liquid crystal panel 20, and between the cover plate 211 and the liquid crystal panel 20, respectively. For example, the buffer material 25 can be an elastic material such as rubber and elastic particles and is attached to the support portion 232, the cover plate 211, and the liquid crystal panel 20 directly. The elastic material is not limited here.

Hereinafter, the second embodiment of the present invention will be described with reference to FIG. 2. FIG. 2 shows the positioning of the frame unit and the liquid crystal panel 20. The cover plate 211 presses the upper surface of the liquid crystal panel 20 using the buffer material 25. The support portion 332 supports the lower surface of the liquid crystal panel 20 using the buffer material 25. A lateral side of the liquid crystal panel 20 props the rib 212 using the buffer material 25. Since the rib 312 works with the lateral side of the liquid crystal panel 20 directly, the thickness of the frame unit is only the thickness of the rib 212 which props the liquid crystal panel 20. So the thickness of the bezel is greatly reduced. Also both of the upper surface of the liquid crystal panel 20 and the lateral side of the liquid crystal panel 20 prop the frame 21, so the liquid crystal panel 20 can be propelled to a predetermined position with the rib 212 of the frame 21. Therefore, the liquid crystal panel 20 is accurately positioned. Further, automated assembly of the LCD device is implemented.

The cover plate 211 on the frame 21 is used for propping the upper surface of the liquid crystal panel 20 flexibly. The rib 212 on the frame 21 is used for propping the lateral side of the liquid crystal panel 20 flexibly. This design allows the liquid crystal panel 20 to be positioned accurately, which is good for implementing automated assembly for the LCD device. Also, it is unnecessary to use the rib 212 of the housing 23 to position the liquid crystal panel 20 horizontally. In other words, the thickness of the bezel of the LCD device is reduced, thereby implementing, the LCD device comprising an extremely narrow bezel.

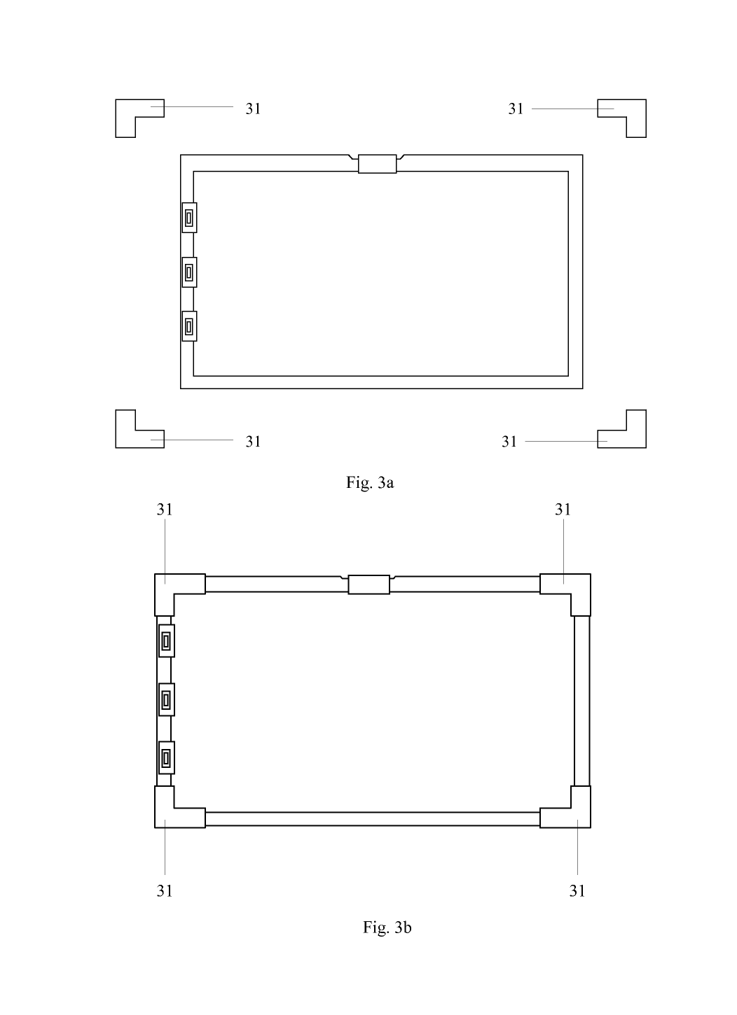

For further information, please refer to FIGS. 3a and 3b. FIG. 3a shows an assembly diagram of an LCD device according to another embodiment of the present invention. FIG. 3b shows a schematic diagram of the completed LCD device as shown in FIG. 3a.

As mentioned above, the frame unit comprises a frame 31 and a back plate unit (not shown).

A plurality of frames 31 are used in FIGS. 3a and 3b. The plurality of frames 31 are L-shaped. The plurality of frames 31 are distributed over the lateral side of the liquid crystal panel or over a plurality of coners and are spaced from one another. Preferably, four frames 31 are used. Also, the liquid crystal panel comprises four corners. The four frames are distributed over the our corners of the liquid crystal panel, respectively. Moreover, considering the positioning of the L-shaped frame 31 on the liquid crystal panel, the plurality of frames 31 may be stripe-shaped. Actually, the shape of the plurality of frames 31 is not limited here.

Further, an LCD device is provided in the present invention. The LCD device comprises a liquid crystal panel and an above-mentioned frame unit. The frame unit comprises a frame, a back plate unit, etc. As mentioned above, a cover plate disposed on the frame is used for propping, the upper surface of the liquid crystal panel flexibly. A rib disposed on the frame is used for propping a lateral side of the liquid crystal panel flexibly. A bottom plate disposed on the back plate unit is used for supporting an optical component of the LCD device. The side plate disposed on the back plate unit works with the rib for propping the liquid crystal panel. Further, as housing can be disposed in another embodiment. The housing comprises a vertical portion and a support portion. The vertical portion is inserted between at rib and a side plate. The support portion props the lower surface of the liquid crystal panel. Since the components used in this embodiment are the same as those used in the above-mentioned embodiments, there will be no further details provided below.

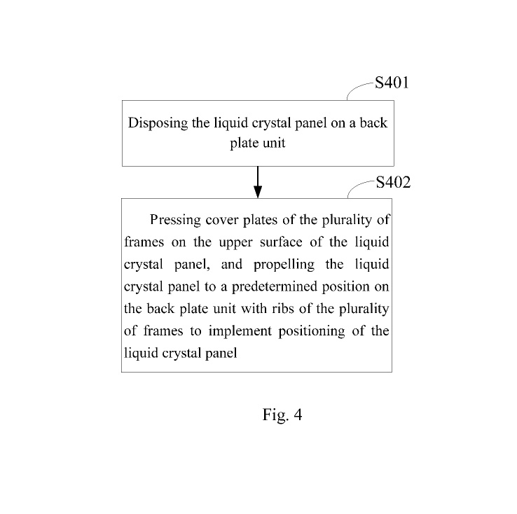

Refer to FIG. 4 showing a flow chart of an alignment method of the liquid crystal panel according to an embodiment of the present invention. The above-mentioned frame unit is used in the alignment method of the liquid crystal panel. The frame unit comprises a frame and a back plate unit. Actually, one or more frames may be used. The alignment method comprises steps of

Step S401: Dispose as liquid crystal panel on a back plate unit,

Step S402: The cover plates of a plurality of frames press the upper surface of the liquid crystal panel. The ribs of the plurality of frames propel the liquid crystal panel to a predetermined position on the back plate unit. In this way, the liquid crystal panel can be positioned.

In the above-mentioned embodiments, the side plate works with the. rib to prop the liquid crystal panel together as described in Step S402. In another embodiment, the housing disposed on the frame unit directly supports the lower surface of the liquid crystal panel. Since the operation of the housing is elaborated in the above-mentioned embodiment, there will be no further details provided below.

According to the alignment method of the liquid crystal panel, the liquid crystal panel is disposed on the back plate unit. The cover plates of the plurality of frames press the upper surface of the liquid crystal panel. The ribs of the plurality of frames propel the liquid crystal panel to a predetermined position to implement accurate positioning of the liquid crystal panel, which is good for implementing automated assembly for the LCD device. Also, it is unnecessary to use the rib of the housing to position the liquid crystal panel horizontally. In other words, the thickness of the bezel of the LCD device is reduced, which implements the design of the extremely narrow bezel of the liquid crystal panel.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A frame unit for a liquid crystal display (LCD) device, comprising a frame and as back plate unit:
the frame comprising a cover plate and a rib perpendicular to the cover plate, the cover plate for propping a upper surface of a liquid crystal panel of the LCD device flexibly, and the rib for propping a lateral side of the liquid crystal panel flexibly;
the back plate unit comprising a bottom plate and a side plate, the bottom plate used for supporting an optical component of the LCD device, and the side plate working with the rib to prop the liquid crystal panel;
wherein the rib comprises a first rib, a second rib, and a connecting portion connected to the first rib and the second rib, the first rib is disposed closely to the lateral side of the side plate, the connecting portion is disposed close to the end surface of the side plate, and the second rib extends from the connecting portion in the direction against the side plate and is connected to the cover plate.

2. The frame unit as claimed in claim 1 further comprising a housing, wherein the housing comprises a vertical portion and a support portion, the vertical portion is inserted between the rib and the side plate, and the support portion props a lower surface of the liquid crystal panel.

3. The frame unit as claimed in claim 2, wherein a containing tank is formed among the support portion, the second rib, and the cover plate for containing and fixing the liquid crystal panel.

4. The frame unit as claimed in claim 3, wherein a buffer material is disposed between the second rib and the lateral side of the liquid crystal panel, between the cover plate and the upper surface of the liquid crystal panel, and between the support portion and the lower surface of the liquid crystal panel.

5. The frame unit as claimed in claim 1, wherein the frame is numerous in quantity, and the plurality of frames are spaced from one another.

6. The frame unit as claimed in claim 5, wherein the plurality of frames are L-shaped and are disposed on a plurality of coners of the liquid crystal panel.

7. A liquid crystal display device, comprising a frame unit, the frame unit comprising a frame and a back plate unit;
the frame comprising a cover plate and a rib perpendicular to the cover plate, the cover plate for propping a upper surface of a liquid crystal panel of the LCD device flexibly, and the rib for propping a lateral side of the liquid crystal panel flexibly;
the back plate unit comprising a bottom plate and a side plate, the bottom plate used for supporting an optical component of the LCD device, and the side plate working with the rib to prop the liquid crystal panel.

8. The liquid crystal display device as claimed in claim 7, wherein the rib comprises a first rib, a second rib, and a connecting portion connected to the first rib and the second rib, the first rib is disposed closely to the lateral side of the side plate, the connecting portion is disposed close to the end surface of the side plate, and the second rib extends from the connecting portion in the direction against the side plate and is connected to the cover plate.

9. The liquid crystal display device as claimed in claim 8, wherein the frame unit further comprises a housing, the housing comprises a vertical portion and a support portion, the vertical portion is inserted between the rib and the side plate, and the support portion props a lower surface of the liquid crystal panel.

10. The liquid crystal display device as claimed in claim 9, wherein a containing tank is formed among the support portion, the second rib, and the cover plate for containing and fixing the liquid crystal panel.

11. The liquid crystal display device as claimed in claim 10, wherein a buffer material is disposed between the second rib and the lateral side of the liquid crystal panel, between the cover plate and the upper surface of the liquid crystal panel, and between the support portion and the lower surface of the liquid crystal panel.

12. The liquid crystal display device as claimed in claim 7, wherein the frame is numerous in quantity, and the plurality of frames are spaced from one another.

13. An alignment method of a liquid crystal panel of an LCD device, wherein the alignment method adopts a frame unit as claimed in claim 1, the frame is numerous in quantity, and the alignment method comprises steps of:
disposing the liquid crystal panel, on a back plate unit;
pressing cover plates of the plurality of frames on the upper surface of the liquid crystal panel, and propelling the liquid crystal panel to a predetermined position on the back plate unit with ribs of the plurality of frames to implement positioning of the liquid crystal panel;
wherein the side plate works with the rib to prop the liquid crystal panel.
